(19) United States
(12) Patent Application Publication
(10) Pub. No.: US 2016/0122207 A1
(43) Pub. Date: May 5, 2016

(54) METHOD FOR SURFACE TREATMENT OF SIEVED STEEL SLAG FOR INCREASING PHOSPHORUS REMOVAL CAPACITY

(71) Applicant: THE BOARD OF REGENTS FOR OKLAHOMA STATE UNIVERSITY, STILLWATER, OK (US)

(72) Inventor: CHAD J. PENN, Stillwater, OK (US)

(21) Appl. No.: 14/842,453

(22) Filed: Sep. 1, 2015

Related U.S. Application Data
(60) Provisional application No. 62/073,707, filed on Oct. 31, 2014.

(51) Int. Cl. C02F 1/28; B01J 20/32

(52) U.S. Cl. CPC C02F 1/288; B01J 20/3236; C02F 1/281; C02F 2101/105

(57) ABSTRACT

A method of preparing a contaminant phosphorous adsorber comprises providing a slag material, sieving the slag material to remove particles smaller than about 0.5 millimeters in diameter and precipitating amorphous Al hydroxide minerals on the surface of the sieved slag prior to exposing the slag to phosphorous.

### CROSS REFERENCE TO RELATED APPLICATIONS

This application claims the benefit of U.S. Provisional Patent Application Ser. No. 62/073,707 filed on Oct. 31, 2014, and incorporates said provisional application by reference into this document as if fully set out at this point.

### BACKGROUND

Excessive phosphorus (P) in surface waters causes eutrophication thereby resulting in excessive plant growth, fish kills, poor drinking water quality, and overall decrease in environmental quality/recreation. Potential sources of phosphorus to surface waters include waste-water treatment plants, horticultural operations, and runoff from agricultural and urban/suburban land, including golf courses.

Soils become saturated with phosphorus through continuous over application of phosphorus to growing plants. The soils with high levels of phosphorus then slowly release dissolved phosphorus in runoff or drainage. There are currently no effective best management practices (BMPs) for immediately reducing transport of dissolved phosphorus. Most BMPs only prevent erosion, which will only reduce particulate phosphorus transport, not dissolved phosphorus. Even if all phosphorus applications to high phosphorus soils are stopped, it will require at least 15 years for soil phosphorus concentrations to decrease to acceptable levels if plants are harvested from the site. In the meantime, these soils will release dissolved phosphorus during every runoff event. Dissolved phosphorus presents a greater and more immediate problem compared to particulate phosphorus (i.e., phosphorus adsorbed onto soil particles) because dissolved phosphorus is 100% bio-available to aquatic organisms. In regard to runoff, dissolved phosphorus is a difficult form to control since particulate losses are typically controlled by maintaining sufficient soil cover and reducing erosion. Dissolved phosphorus loads in runoff and drainage are greatest from soils that are high in soil test phosphorus and soils with recent surface applications of phosphorus.

A possible solution to the problem of excess phosphorus is the application of phosphorus sorbing materials to affected soils. Such materials can be applied directly to the soil or included with applied animal manures. These techniques have been shown to reduce dissolved phosphorus transport in runoff during rainfall events. However, phosphorus sorbed onto these materials may become soluble again with time, or due to changes in chemical conditions. Therefore, phosphorus is not truly removed from the system, only temporarily made insoluble.

Another potential solution is direct application of phosphorus sorbing materials to surface waters (lakes, ponds, etc.). This has been shown to be effective for reducing soluble phosphorus concentrations in the water column of various lakes. However, this approach only reduces the solubility of phosphorus in the system; phosphorus is not actually removed from the water. The sorbed phosphorus can be re-dissolved with time, or upon changes in chemical conditions.

What is needed is a system and method for immediately addressing the above, and related, issues. Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

The invention of the present disclosure, in one aspect thereof, comprises a method of preparing a contaminant phosphorous adsorber comprising providing a slag material or other alkaline material, sieving the material to remove particles smaller than about 0.5 millimeters in diameter resulting in a sieved material, and precipitating amorphous Al hydroxide minerals on the surface of the sieved material prior to exposing the material to phosphorous resulting in a sieved, coated material.

The method may include enclosing the sieved, coated material in a cell that allows water to saturate the sieved, coated material and possibly placing the cell in a path of water flow.

The invention of the present disclosure, in another aspect thereof, comprises a method of constructing a phosphorous adsorbing cell including providing a slag material comprising slag particles that are substantially uncontaminated by phosphorous, retaining the slag material in a cell that allows water to saturate the slag but retains the slag material, and precipitating amorphous Al hydroxide minerals onto surfaces of the slag particles resulting in a coated slag retained in the cell prior to placing the cell in a water runoff path.

This method may include precipitating the amorphous Al hydroxide minerals onto the surface of the slag particles prior to placing the slag in the cell. In another embodiment, the amorphous Al hydroxide minerals are precipitated onto the surface of the slag particles after to placing the slag in the cell (prior to exposure to water runoff. The slag material may be sieved prior to precipitating amorphous Al hydroxide minerals onto surfaces of the slag particles. The slag may be sieved to remove particles smaller than about 0.5 mm in diameter.

The invention of the present disclosure, in another aspect thereof, comprises a method of preparing a phosphorous adsorber comprising providing a base material comprising particles having a porous surface, (if necessary) preparing a alkalinizing solution and exposing the base material to the alkalizing solution to alkalize the porous surfaces of the particles of the base material, and precipitating amorphous Al hydroxide minerals onto alkalized porous surfaces of the particles of the base material.

The method may include the use of sand, light expanded clay aggregate, steel slag, zeolite, ceramic particles or other materials as a base material. The alkalinizing solution may include sodium hydroxide, a calcium oxide, slag fines or other substances.

The method may further comprise titrating a sample of the base material to determine a pH of the base material and calculating a quantity of alkalizing solution needed to impact a desired pH to the base material prior to precipitating amorphous Al hydroxide minerals. The desired pH may range from about 8 to about 12.

The base material may be retained in a cell allowing water flow therethrough but retaining the base material. The cell may be placed in a water runoff path.

### BRIEF DESCRIPTION OF THE DRAWINGS

These and further aspects of the invention are described in detail in the following examples and accompanying drawings.

FIG. 1a is a side view cutaway diagram of a phosphorus removal system according to the present disclosure.

FIG. 1b is a perspective view of a phosphorus retention cell according the present disclosure.

FIG. 2a is a data plot illustrating phosphorus sorption under flow-through conditions in the laboratory and also in the field for uncoated 6 millimeter slag.

FIG. 2b is a data plot illustrating phosphorus sorption under flow-through conditions in the laboratory and also in the field for coated 6 millimeter slag.

FIG. 3 is a data plot illustrating results of the field testing of coated slag compared to non-coated slag.

FIG. 4 is a graph of phosphorus load to slag for modified and fresh slag.

FIG. 5 is a graph comparing phosphorus sorbed by uncoated sand versus phosphorus sorbed by aluminum coated sand for various concentrations of phosphorus.

### DETAILED DESCRIPTION

The instant invention is not to be limited in its application to the details of the construction and to the arrangements of the components set forth in the following description or illustrated in the drawings. While this invention is susceptible of embodiment in many different forms, it is shown in the drawings, and will be described hereinafter in detail, some specific embodiments of the instant invention. It should be understood, however, that the present disclosure is to be considered an exemplification of the principles of the invention and is not intended to limit the invention to the specific embodiments or algorithms so described. Rather, the invention is capable of other embodiments and of being practiced and carried out in various other ways not specifically enumerated herein. Finally, it should be understood that the phraseology and terminology employed herein are for the purpose of description and should not be regarded as limiting, unless the claims specifically so limit the invention.

Phosphorus (sometimes denoted “P”) sorbing materials can be used in an isolated structure for treating phosphorus rich runoff prior to the runoff reaching surface bodies of water. An example of a phosphorus removal effort includes construction of a phosphorus removal structure in a surface water drainage ditch. Various phosphorus removal structures associated with the present are designed to force flowing water through sorption materials such as industrial by-products. Clean water is allowed to exit the structure, which is designed to prevent the sorption material from being lost. Methods for design and construction of a phosphorous removal structure may be found in U.S. Pat. No. 8,754,004, herein incorporated by reference.

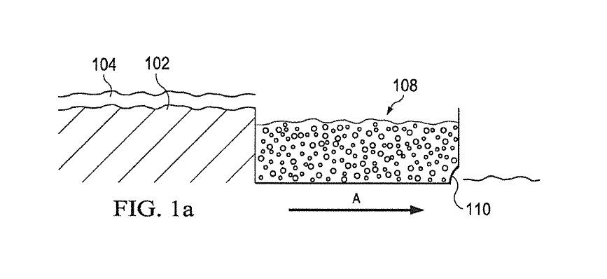

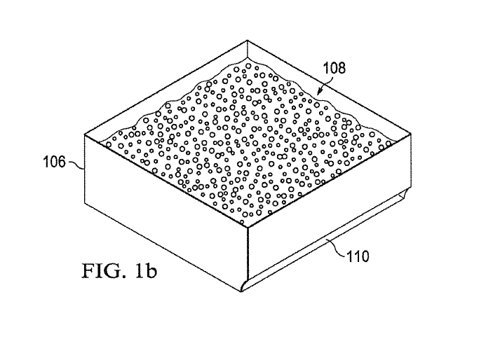

Reference is now made to FIG. 1, which is a side cutaway diagram of an exemplary P removal system according to the present disclosure. In FIG. 1 the system 100 comprises a cell 106 placed at the outlet of a spillway 102 (or other landscape). Water (containing phosphorus contamination) flows into the cell 106, which contains a quantity of a P sorbing material or sorbent 108 that absorbs or adsorbs phosphorus. An outlet 110 is provided that allows the water 104 to escape the cell 106, but which retains the sorbing material 108 along with the captured phosphorous. The cell 106 will be placed such that the water generally flows through the cell 106 toward the outlet 110 as shown by arrow A. It is understood that the P removal system 100 can be placed in any water path or watercourse including ditches, culverts, streams, channels, pipes, etc. The system 100 may find the greatest effect in P removal if it can be placed such that all or a majority of the P contaminated runoff from a given area can be forced to flow through the cell 106.

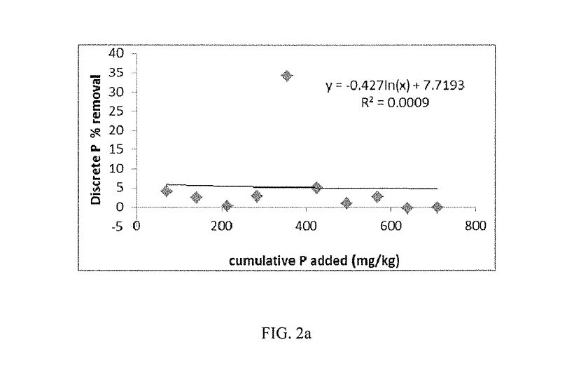

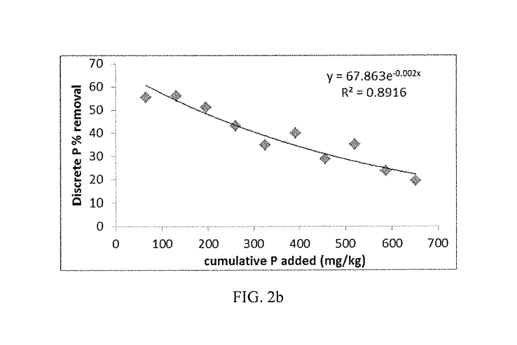

Referring now to FIG. 2, the cell 106 is shown in perspective. The cell 106 may be made from a metal, a polymer, or some other resilient material that will prevent water from escaping except via the outlet 110. Supports and other auxiliary structures may be utilized as needed. The outlet 110 may be provided with a screen or other water permeable covering to retain the sorbent 108, but allow water to escape. It is understood that the flow rate and retention time of water entering the cell 106 may be controlled by adjustment of the dimensions of the cell, the dimensions of the opening, and by the physical characteristics of the sorbent 108. In implementing a P removal system 100, it may be useful to be able to predict the amount of phosphorus that can be removed over a given time, the expected useful lifetime of the system 100, and other information. Such methods are disclosed, for example, in U.S. Pat. No. 8,754,004, previously incorporated by reference

The sorbent 108 contained in the cell 106 may comprise an iron rich by-product that possesses a high phosphorus sorption capacity. Examples of sorptive materials that could be employed would include acid mine drainage residuals, flue gas desulfurization gypsum, steel slag, and drinking water treatment residuals. These are all considered industrial by-products in most respect and would often be considered a waste product. A by-product from the steel industry that has potential for use in phosphorus removal structures is steel slag. Both Ca and Fe rich waste products can be utilized to treat wastewater streams. In addition, it has been found that a mixture of “basic” and “melter” slag backfilled around subsurface drainage pipes and overlaid by phosphorus rich topsoils can significantly reduce dissolved phosphorus concentrations in drainage waters. Testing of phosphorous removal structures utilizing acid mine drainage residuals as an adsorbing agent has revealed that single rainfall events that lasted up to 18 hours, a properly design structure can remove up to 99% of the dissolved phosphorus that entering it. In another study, a melter slag was utilized as a filter material at a wastewater treatment plant for 11 years. It was found that 77% of total phosphorus was removed during the first 5 years of operation.

The systems of the present disclosure are useful for removing dissolved phosphorus from surface runoff or drainage water by sorption (e.g., precipitation or ligand exchange, of phosphorus onto sorption materials). The ability of a structure such as that in FIGS. 1A-B, and similar structures, to efficiently remove P depends on two factors: use of a material that has a strong affinity for P; and the ability to channel water through the material so that the P in the water can sorb to the material (i.e., hydraulic conductivity). While many by-products serve well as P sorbents, many suffer from having a low hydraulic conductivity, which reduces the ability of the material to flow water through it, and thereby reduces its utility as a P filter material.

Unmodified steel slag as a sorbent is that tends to suffer from low hydraulic conductivity that worsens when the containment structure beings to clog from use. Where a material of low hydraulic conductivity is utilized, a larger surface area and shallow depth is necessary in the dimensions of the cell 106 in order to achieve the desired flow rate. The amount of water that can actually be treated with such a device can be limited depending on the material used and the physical attributes of the containment structure or cell 106. High throughput is critical for sites that produce large volumes and flow rates of runoff.

According to methods of the present disclosure, steel slag and other materials can be processed or treated to improve hydraulic conductivity (or decrease the rate of loss of hydraulic conductivity) while maintaining a highly effective degree of P sorptive properties. In one embodiment, unmodified steel slag is sieved to remove particles smaller than about 0.5 millimeters in diameter prior to being placed in cell 106 or other P removal structure. This both ensures an initially high hydraulic conductivity and reduces or prevents clogging that can decrease hydraulic conductivity over time. Furthermore, the sieved slag can be treated with Al hydroxide either prior to, or after, being placed into the cell 106 to even further improve the sorptive qualities.

A structure was constructed in accordance with the present disclosure that contained 6 millimeter steel slag. It operated for 2 years without flow reduction issues. While the 6 millimeter steel slag was effective as a P filter material, it was not as sorptive as finer size fractions that experience clogging. Slag materials are relatively alkaline (high pH) and dominated with calcium (“Ca”) minerals. While Ca is an effective element for precipitation of P in water, it is not as effective as aluminum (“Al”). Due to the alkaline nature of the slag, aluminum can be precipitated onto the surfaces forming a new amorphous Al hydroxide mineral, which is extremely reactive with P: Al³⁺+3OH⁻→AL(OH)_{3(solid)}.

The Al³⁺ solution is supplied with dissolved Al sulfate, Al chloride, or other highly soluble Al forms. The slag naturally produces the OH— (hydroxide) due to its alkaline nature, which is what causes the Al³⁺ to precipitate as a solid and coat the surface of the slag. Coated slag material may appear white due to the Al hydroxide coating that forms. The process may be achieved by soaking the sieved slag material with an Al sulfate solution at a concentration of 94.5 g Al sulfate/l for 48 hrs, followed by drainage and drying in situ for several days. Note that this coating process can be conducted in situ, within the filter structure, or prior to placing the slag into the cell 106 or other containment structure.

In addition to the formation of Al hydroxide solid, the acidic Al sulfate solution dissolves many of the Ca minerals and precipitates Ca sulfate, which is also an effective material at removing P. Note that the drainage water contains little to no aluminum and is not excessively acidic (pH 6) due to neutralization by the slag material, which is what causes the precipitation of the Al hydroxide solids. The chemistry of aluminum sulfate solution and the initial slag surface complement each other with regard to precipitation of aluminum hydroxide solids. The coating process results in an increase in ammonium oxalate extractable aluminum, considered to be representative of amorphous Al hydroxide minerals, from 315 to 2737 mg/kg. Water soluble Ca was also increased from 249 to 5818 mg/kg: this will also increase P sorption.

The material prepared as described was tested for phosphorous sorption under flow-through conditions in the laboratory and also in the field. FIG. 2a shows P removal (normalized for P added) for the sieved, unused, and non-coated slag (>6 millimeter fraction) and FIG. 2b illustrates the dramatic increased P removal for the coated slag (>6 millimeter fraction), under laboratory flow-through conditions.

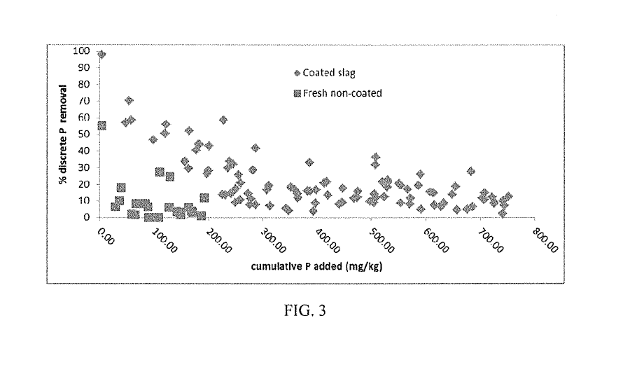

The coated stag was also tested in the field (in a pond filter structure) and compared to a non-coated 0.5 mm size fraction. FIG. 3 shows the results of the field testing of coated slag compared to the non-coated. The dramatic improvement of the slag P removal from the coating process will save a tremendous amount of material, transportation, and cost, with regard to the construction of P removal structures. For example, a P removal structure can be designed for typical dissolved P concentrations in runoff, average annual flow volume, anticipated flow rate for a 2 yr-24 hr storm, and the desired P removal lifetime. The necessary mass of a P sorbing material can then be determined. In one such example, 120 tons of non-coated slag, which would only remove 25% of the annual P load compared to only 40 tons of the coated slag which would remove 40% of the annual P load. Based on the current cost of aluminum sulfate, it will only cost $400 to coat 40 tons.

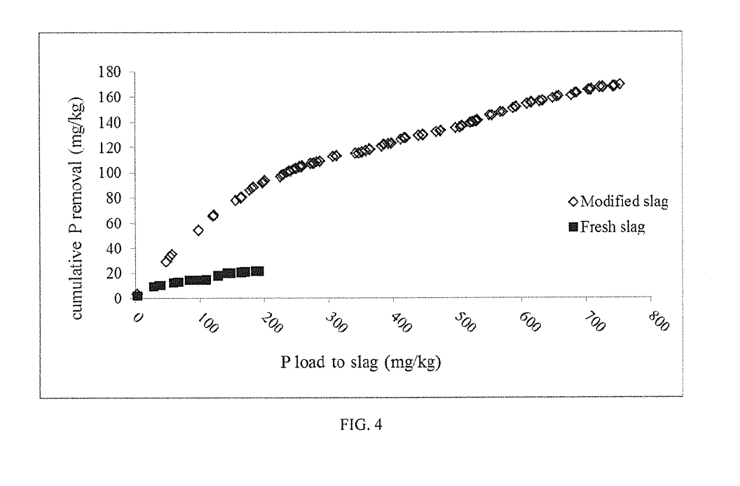

FIG. 4 is a graph of P load to slag for modified and fresh slag.

It should be appreciated from the foregoing that by sieving and pretreating slag with aluminum sulfate the adsorption properties of the slag (and the devices into which is may be integrated) may be greatly enhanced. This allows devices to be smaller and more economical because they can contain less slag for a given adsorption capacity. The costs associated with coating the slag before use does not negate the savings in size or raw material that may be realized.

It should also be appreciated that the coating process for the slag could take place either before or after a P capturing system is in place. Therefore, methods of the present disclosure may be useful in enhancing existing P capture systems that currently rely on uncoated slag.

Materials other than steel slag can also serve as a base substance that can be treated to make a sorbent 108. Material with sufficient surface porosity or surface area can be treated with an alkalinizing solution to make it receptive to treatment with aluminum as described above. Iron may also be precipitated to an alkaline material to create an effective sorbent. A granular or particulate material may be more readily adaptable for use as the sorbent 108 owing to the already higher surface area per weight or volume compared to a monolithic or large chunk embodiment. Tradeoffs may occur when selecting particle grain size as smaller particle size may have the ability to trap more phosphorous, but at the expense of lower hydraulic conductivity and/or greater propensity to clog. Nevertheless, as described herein, the aluminum coating acts not only as a phosphorous sorbent but can also improve hydraulic conductivity of the base material and/or reduce its propensity to clog.

Materials useful as a sorbent (when treated with an alkalinizing solution followed by aluminum or iron precipitation) include sand, ceramics, zeolites, light expanded clay aggregates (LECA), and other materials with a high surface porosity or surface area per volume. An appropriate alkalinizing solution can be prepared from a number of chemicals or substances including sodium hydroxide, sodium carbonate, calcium oxide, calcium hydroxide, calcium carbonate and other chemicals. Beneficially, steel slag is also quite alkaline itself. Fines or very small particles of slag can be used in an alkalinizing solution used to treat the base non-alkaline substance prior to precipitation of aluminum hydroxide. A ready supply of steel slag fines may be available of a practitioner of systems or methods of the present disclosure sieves slag to obtain larger particles for use as a sorbent as described above.

With a properly alkalinized material, aluminum hydroxide, aluminum chloride, aluminum sulfate, or various other aluminum or iron solutions may be used to precipitate aluminum or iron onto the material.

In order to determine an amount or concentration of alkalinizing solution necessary to provide the proper alkalinity to the raw sorbent base, a sample of the untreated sorbent base may be titrated to determine its initial pH. With a determination of the initial pH, the quantity of sorbent base to be alkalinized can be treated with only the appropriate amount and concentration of the chosen alkalinizing solution. This may be important when materials are treated in situ in order to prevent waste or harmful alkaline runoff. In order for the alkalinized sorbent to properly retain the aluminum or iron coating, it may need to have a surface pH of about 9, although a range from 8 to 12 is effective.

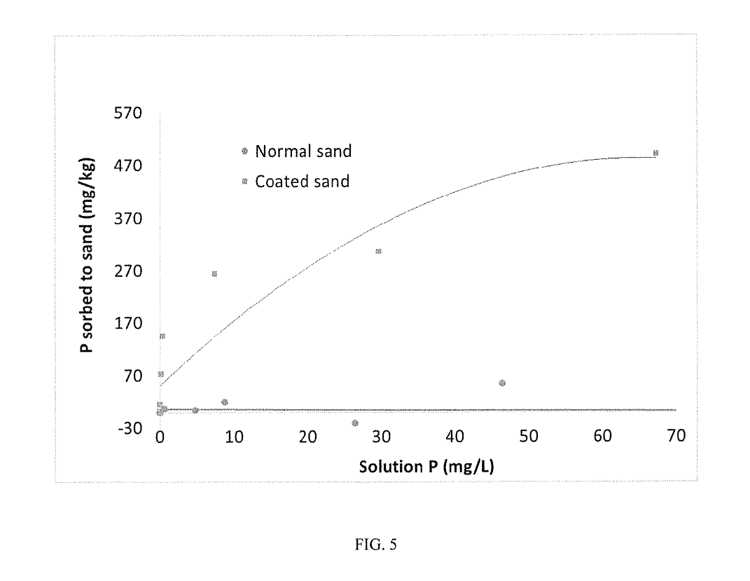

Referring now to FIG. 5, an illustration of use of a sand material as a P sorbent in treated and untreated forms for various concentrations of P is shown. It can be seen that the sand material shows a dramatic increase in ability to sorb and retain phosphorous when treated according to the present disclosure. In this particular example, the sand material was pre-treated with a solution of sodium hydroxide, at a concentration determined by first conducting a pH titration on the sand (the sand could also have been made alkaline by soaking it in a solution of dissolved slag fines). After draining and drying, the sand was soaked in a solution of aluminum chloride, followed by draining and drying.

It is to be understood that the terms “including”, “comprising”, “consisting” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A method of preparing a contaminant phosphorous adsorber comprising:
providing a slag material;
sieving the slag material to remove particles smaller than about 0.5 millimeters in diameter resulting in a sieved slag; and
precipitating amorphous Al hydroxide minerals on the surface of the sieved slag prior to exposing the slag to phosphorous resulting in a sieved, coated slag.

2. The method of claim 2, further comprising enclosing the sieved, coated slag in a cell that allows contaminant water to flow through and become exposed to the sieved, coated slag.

3. The method of claim 2, further comprising placing the cell in a path of water flow.

4. A method of constructing a phosphorous adsorbing cell comprising:
proving a slag material comprising slag particles that are substantially uncontaminated by phosphorous;
retaining the slag material in a cell that allows water to flow therethrough but retains the slag material;
precipitating amorphous Al hydroxide minerals onto surfaces of the slag particles resulting in a coated slag retained in the cell prior to placing the cell in a water runoff path.

5. The method of claim 4, wherein the amorphous Al hydroxide minerals are precipitated onto the surface of the slag particles prior to placing the slag in the cell.

6. The method of claim 4, wherein the amorphous Al hydroxide minerals are precipitated onto the surface of the slag particles after to placing the slag in the cell.

7. The method of claim 4, further comprising sieving the slag material prior to precipitating amorphous Al hydroxide minerals onto surfaces of the slag particles.

8. The method of claim 7, wherein the sieving removes slag particles smaller than about 0.5 millimeters in diameter.

9. A method of preparing a phosphorous adsorber comprising:
providing a base material comprising particles having a porous surface;
preparing a alkalinizing solution;
exposing the base material to the alkalizing solution to alkalize the porous surfaces of the particles of the base material; and
precipitating amorphous Al hydroxide minerals onto alkalized porous surfaces of the particles of the base material.

10. The method of claim 9, further comprising using sand as a base material.

11. The method of claim 9, further comprising using LECA as a base material.

12. The method of claim 1, further comprising using a zeolite as a base material.

13. The method of claim 1, further comprising using ceramic particles as a base material.

14. The method of claim 1, further comprising using sodium hydroxide in the alkalizing solution.

15. The method of claim 1, further comprising using a calcium oxide in the alkalinizing solution.

16. The method of claim 1, further comprising using slag fines in the alkalizing solution.

17. The method of claim 1, further comprising titrating a sample of the base material to determine a pH of the base material and calculating a quantity of alkalizing solution needed to impact a desired pH to the base material prior to precipitating amorphous Al hydroxide minerals.

18. The method of claim 17, wherein the desired pH is from about 8 to about 12.

19. The method of claim 1, further comprising retaining the base material in a cell allowing water flow therethrough but retaining the base material.

20. The method of claim 10, further comprising placing the cell in water runoff path.
